(19) United States
(12) Patent Application Publication
(10) Pub. No.: US 2007/0267544 A1
(43) Pub. Date: Nov. 22, 2007

(54) Aircraft with improved cargo hold

(75) Inventors: Luis Gonzalez Linero, Bristol (GB); Stuart Alexander, (US)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 11/798,825

(22) Filed: May 17, 2007

(30) Foreign Application Priority Data
May 18, 2006 (GB) GB0609890.9

(51) Int. Cl. B64D 11/00

(52) U.S. Cl. 244/118.5

(57) ABSTRACT

An aircraft according to one embodiment has a fuselage which houses an upper level and a lower level separated by the floor of the upper level, wherein at least one of the cross-sectional shape of the fuselage and the floor of the upper level is configured such that the ceiling height in at least part of both the upper and lower levels is sufficient for a person to stand, and one of the upper and lower levels comprises a passenger cabin and the other level comprises a cargo hold. There is also provided, according to another embodiment a method of operating an aircraft having a fuselage which houses an upper level and a lower level separated by the floor of the upper level. The method may comprise the steps of directing passengers to embark onto the lower level of the aircraft and to deposit their luggage in the lower level, and then directing passengers to move from the lower level to the upper level, wherein the passengers are directed to move along a path such that the position of embarking is upstream of the position at which the luggage is deposited which is upstream of the position at which passengers move to the upper level.

### RELATED APPLICATIONS

The present application is based on, and claims priority from, UK Patent Application Number 0609890.9, filed May 18, 2006, the disclosure of which is hereby incorporated by reference herein in its entirety.

### BACKGROUND OF THE INVENTION

The present invention relates to an aircraft having a passenger cabin and a cargo hold.

Passenger aircraft are equipped to carry luggage belonging to passengers travelling on the aircraft, in addition to other packages being carried as freight. The luggage is generally carried in a cargo hold of the aircraft, located beneath the floor of the passenger cabin. The cargo hold is a separate area of the aircraft, to which, in conventional designs, passengers do not have access.

Since passengers do not have access to the cargo hold little consideration is given to the ease and comfort of access to the cargo hold, with the principle consideration being the capacity of the hold. Since priority is given to the comfort of the passenger cabin the height of the cargo hold is generally significantly less than the height of a person, thereby preventing a person comfortably standing or walking in the cargo hold.

The fuselage of a passenger aircraft forms a pressure vessel in order to provide a passenger cabin at substantially atmospheric pressure when the air pressure outside of the aircraft is reduced when flying. A circular cross-section provides an efficient pressure vessel and consequently it is preferable for aircraft fuselages to have a cross-section that is circular or close to circular.

The external shape of the fuselage of an aircraft is an important factor in that aircraft's aerodynamic performance. Aerodynamic drag is dependent on, inter alia, the frontal area and the surface area of the aircraft. In order to reduce drag, and therefore improve performance, the frontal area and surface area of an aircraft should thus be minimised. Furthermore, there is a desire to minimise the mass of the aircraft and/or to maximise the volume available for carrying passengers and luggage for a given mass of aircraft. A fuselage having a circular cross-section may optimise the internal volume against surface area ratio since a circle has the minimum circumference for a given area. A circular cross-section is also an effective design to provide a fuselage of the required structural strength.

In the conventional manner of operating aircraft, passengers check-in and deposit their luggage at a check-in desk located in the airport from which they are departing. Luggage is transported from the check-in desks to the required aircraft by airport systems and staff, and then loaded into the cargo hold of the aircraft by luggage handling staff. When an aircraft arrives at a destination the luggage is off-loaded by luggage handling staff and transported to a luggage collection hall, from where passengers can collect their luggage.

Airports have a number of check-in desks and many aircraft may be departing and arriving at any given time. It is therefore necessary to identify each item of luggage and route it between the check-in desk and the correct aircraft. Also, luggage must be routed from arriving aircraft to an appropriate luggage collection hall. The transport of luggage to and from aircraft can be a complex, expensive, time-consuming and labour intensive task.

In order to avoid the inadvertent carriage of dangerous goods, for example explosive devices, only luggage belonging to passengers who actually board an aircraft can be carried. It is common for passengers not to arrive at their aircraft on time for their flight, but since their luggage may have already been loaded onto the aircraft, the flight cannot depart until either the luggage is off-loaded or the passenger arrives. This can cause significant delays to the departure of the flight, thereby reducing customer satisfaction, and increasing an airlines cost due to schedule disruption.

FIG. 1 shows a cross-section of an aircraft of the prior-art. The fuselage houses two levels—an upper passenger cabin 1 and a lower cargo hold 2. As has been described above luggage is loaded into the cargo hold 2 by airport staff, while passengers board the aircraft directly into the passenger cabin 1. Since passenger comfort is a priority when designing an aircraft, the internal floor 3 is positioned such that there is sufficient headroom in the passenger cabin for passengers to stand and walk in the central aisle, and to comfortably move into and out of the seats located in the passenger cabin. The location of the floor at a suitable location to provide the above features means that the height of the cargo hold is substantially less than the height of a person. The height of the cargo hold is sufficient for the storage of luggage and cargo, and since the cargo hold only need be accessed by airport staff, the lack of the ability to stand in the cargo hold does not pose significant disadvantages.

The present invention seeks to provide an improved system for storing luggage, for example in the form of an improved aircraft, and/or in the form of an improved luggage handling method.

Alternatively, or additionally, the present invention seeks to provide an aircraft and/or a method of operating an aircraft that mitigates one or more of the above-mentioned disadvantages.

### SUMMARY OF THE INVENTION

The present invention provides, according to a first aspect of the invention an aircraft having a fuselage which houses an upper level and a lower level separated by the floor of the upper level, wherein at least one of (i) the cross-sectional shape of the fuselage and (ii) the floor of the upper level is configured such that the ceiling height in at least part of both the upper and lower levels is sufficient for a person to stand, and one of the upper and lower levels comprises a passenger cabin and the other level comprises a cargo hold.

Thus the height of both levels is such that both levels are readily accessible by people. The cargo hold may be made accessible to passengers, and as such having a height tall enough to allow passengers to stand in the cargo hold may be of significant benefit. Access to the cargo hold may be provided for purposes of depositing, accessing or collecting luggage, or for accessing entertainment facilities, shops, vending machines or sleeping accommodation located in the cargo hold.

It will of course be understood that the cross-sectional shape of the fuselage is the shape of a section defined by the intersection of the fuselage and a plane having a normal axis parallel to the longitudinal axis of the fuselage. The configuration of the fuselage cross-sectional shape effected to arrive at a shape that provides standing room in both levels may be a configuration that deviates from the conventional substantially circular cross-sectional shape.

At least a part of the upper level that has a height sufficient for a person to stand is preferably located at a region the same position along the length of the fuselage as at least a part of the lower level that has a height sufficient for a person to stand.

The cross-sectional shape of the fuselage may be substantially the same along the majority of the length, and preferably substantially the entire length of the passenger cabin. It will of course be appreciated that the cross-sectional shape of the fuselage tapers at the nose and tail ends of the aircraft.

The cargo hold is preferably an area used for storing luggage, cargo, or other equipment, but not used for passenger seating.

The height in each level may for example be no less than 1.8 m, may be greater than 1.9 m and may even be about 2 m or taller.

The cross-sectional shape of the fuselage is preferably such that the passenger cabin is wider than the cargo hold. Such a configuration allows effective use of the width of the fuselage for seating passengers, since the number of passengers able to be seated in the passenger cabin depends more on available floor space and less on available height for standing. Luggage on the other hand can be stored in all available space and so availability of floor space is not as important in the cargo hold as overall available volume.

The fuselage is preferably taller than it is wide. Such a configuration makes the provision of standing room in both the passenger cabin and the cargo hold easier for a given cross-sectional area of fuselage.

The radius of curvature of the lowermost section of the cross-sectional shape of the fuselage may be less than the radius of curvature of a circle having a diameter equal to the width of the aircraft fuselage. Such a configuration makes the provision of standing room in the cargo hold easier for a given cross-sectional area of fuselage.

The radius of curvature of the uppermost section of the cross-sectional shape of the fuselage may be greater than the radius of curvature of a circle having a diameter equal to the width of the aircraft fuselage. Such a configuration makes the provision of a wider passenger cabin easier for a given cross-sectional area of fuselage.

The uppermost and lowermost sections may be defined as those sections which in cross-section are defined by lines that are no more than 30 degrees to the horizontal. The radius of curvature may vary of course along the uppermost section and/or along the lowermost section. In such a case the average radius of curvature should be measured.

The radius of curvature of the uppermost section of the cross-sectional shape may be greater than the radius of curvature of the lowermost section of the cross-sectional shape. The cross-section of the fuselage may thus be generally egg-shaped (the general shape of the cross-section of an egg taken along a plane containing its long axis).

The floor of the upper level may be so configured that the floor is raised in the middle. The floor may thus have a central portion that is higher (above the horizontal) than a portion of the floor at the edge (i.e. at the edge of the floor when viewed in cross-section next to the fuselage shell). Thus, the floor having a raised central portion (or alternatively lowered edge portions) may allow the ceiling height of the lower level to be increased without compromising the height of the upper level at the edges at either side. Embodiments of the invention having such a floor configuration may be particularly advantageous in conjunction with a circular fuselage as it provides the advantages of the upper and a lower levels each being of a height sufficient for a person to stand, together with the advantages of a circular fuselage described hereinbefore.

The cross-sectional shape of the floor may be in the general form of a curve having a peak at the centre of the cross-sectional shape. The floor may have the general shape in cross-section of an arch. Seats may be provided at different heights by being mounted at different positions across the width of the floor, when the upper level comprises the passenger cabin. Arches are of course known for their structurally strong properties. In contrast, floors are of course typically flat in shape.

The floor may have a cross-sectional shape that is stepped, rising from the outside edges to the centre. Thus, the cross-sectional shape of the floor may be in the general form of a stepped arch, possessing the benefit of the generally arched floor mentioned above, but also providing flat floor sections in the upper level. Such flat sections may, when the upper level comprises the passenger cabin, accommodate seating.

Standing height in either level need not be provided across the whole width of the level when viewed in cross-section. Thus, the part of the upper level lying close (in the horizontal direction) to the longitudinal axis of the fuselage preferably has a ceiling height sufficient for a person to stand, but other parts of the upper level lying further from the axis of the fuselage may have a ceiling height insufficient for a person to stand. The ceiling height at the outer edges of the cross-section of the upper-level, in the case where the upper level comprises passenger seating, is preferably sufficient for a person to access a seat positioned at the outer edge of the floor of the upper level. Thus, the height space available at the centreline of such a seat is preferably greater than 1.5 m and more preferably greater than 1.6 m. The height may however be less than 1.8 m.

In a similar manner to that described above, the part of the lower level lying close (in the horizontal direction) to the longitudinal axis of the fuselage may have a ceiling height sufficient for a person to stand, but other parts of the lower level lying further from the axis of the fuselage may be arranged such that there is insufficient room for a person to stand (for example by means of lack of ceiling height and/or other equipment, for example luggage storing equipment, being positioned in the floor space).

Preferably, the upper level comprises the passenger cabin. Preferably, the lower level comprises the cargo hold. The passenger cabin may be equipped with seats arranged in a plurality of rows. The passenger cabin may be equipped with seats arranged in a plurality of columns. The columns may be staggered, in that the rows of seats do not extend exactly perpendicularly across the fuselage. The passenger cabin may include seats arranged such that an aisle is defined along the length of the fuselage, preferably along the centre. There may be between 4 and 7 seats (inclusive) across the width of the fuselage.

Preferably, the aircraft is arranged such that both the upper and lower levels are accessible by passengers. Access to the cargo hold by passengers may be prevented or discouraged during take-off and landing. The aircraft may be arranged such that both the upper and lower levels are accessible by passengers only during embarking and disembarking from the aircraft.

The fuselage may house the upper level, the lower level and no other levels.

The present invention provides according to a second aspect of the invention an aircraft having a fuselage which houses an upper level and a lower level separated by the floor of the upper level, wherein

the floor when viewed in cross-section is raised in the middle. It will of course be understood that the cross-section is one defined by the intersection of the fuselage and a plane having a normal axis parallel to the longitudinal axis of the fuselage. The floor may thus be higher at the centre of the floor than at the edges.

The present invention provides according to a third aspect of the invention an aircraft having a fuselage which houses an upper level and a lower level separated by the floor of the upper level, wherein

the fuselage is taller than it is wide, and the radius of curvature of the lowermost section of the cross-sectional shape of the fuselage is smaller than the radius of curvature of a circle having a diameter equal to the width of the aircraft fuselage. The width may be taken as the greatest horizontal dimension of the fuselage when viewed in cross-section.

In any of the first to third aspects of the invention, seats provided in the passenger cabin may be arranged in rows, each seat being offset in a forwards or backwards direction from a neighbouring seat. In the case where seats are provided at different heights across the width of the fuselage, having such a staggered arrangement may reduce the perception by passengers sitting in the lower seats that they are being overlooked. Preferably, therefore, the lower seats are positioned rearwards (in the opposite direction to that in which passengers face when seated) of higher seats in the same row.

The aircraft may further comprise passenger accessible luggage storage compartments in the cargo hold. The luggage storage compartments may be in the form of lockers for example.

The present invention provides according to a fourth aspect of the invention method of operating an aircraft having a fuselage which houses an upper level and a lower level separated by the floor of the upper level, comprising the steps of:

directing passengers to embark onto the lower level of the aircraft and, to deposit their luggage in the lower level, and then

directing passengers to move from the lower level to the upper level, wherein

the passengers are directed to move along a path such that the position of embarking is upstream of the position at which the luggage is deposited which is upstream of the position at which passengers move to the upper level.

The passengers are thus directed along the path in a one-way stream which may allow passengers to deposit their luggage and proceed to their seats without having to move against the general flow of passengers when embarking the aircraft.

The aircraft further may comprise internal passenger stairs between the lower and upper levels. The internal passenger stairs may be movable between a deployed position and a stowed position. There may be an opening in the floor separating the lower level from the upper level, the stairs being so arranged that, when the internal passenger stairs are in the deployed position, passengers can move between the lower and upper levels via the internal passenger stairs, and when the internal passenger stairs are in the stowed position, the opening in the floor is closed. For example, the method according to certain embodiments of the invention may comprise steps of directing passengers to embark onto the lower level of the aircraft and to deposit their luggage in the lower level, and then directing passengers to move to the upper level via the internal passenger stairs. The passengers may move to the upper level via an opening between the upper and lower levels (for example, said opening mentioned above). Such a method may also include a step of subsequently moving the internal passenger stairs to a stowed position and closing said opening in the floor. Such an internal stair arrangement may be adapted to enable full access to the cargo hold by passengers to be provided.

The aircraft may comprise passenger stairs movable between a deployed position, in which they provide access between the lower level and the outside of the aircraft, and a stowed position. Such stairs may be in the form of external passenger stairs. The word “external” is used simply as a label for the stairs (to distinguish them from passenger stairs that might be referred to as “internal passenger stairs”), and does not suggest that the stairs will always be external to the aircraft. It will for example be understood by the reader that the stairs may be internal to the aircraft when they are in the stowed position.

The external passenger stairs may be arranged to be configurable to provide access between the lower level and the ground. Alternatively, or additionally, the external passenger stairs may provide access between the aircraft and an airbridge or portable stair system. The external stairs may be configured as disclosed in GB Patent Application GB0609892.5 having a filing date of 18 May 2006 entitled “Aircraft Walkway”, Airbus UK Limited ref: XA2220. The contents of that application are fully incorporated herein by reference. For example, the external stairs described therein could be used to provide access to the lower level of an aircraft according to an embodiment of the present invention, whilst internal stairs could be used to provide access from the lower level of the aircraft to the upper level. It will be appreciated that in accordance with certain embodiments of the present invention such internal and external stairs need not, and preferably are not, provided to provide a continuous stairway from the ground directly to the upper level.

The method may be performed such that passengers embark on to the lower level of the aircraft at a different location along the length of the aircraft to the location at which they move to the upper level of the aircraft. The passengers may thus, after embarking on to the lower level, walk along the length of the fuselage, or a part thereof, before moving up to the upper level.

There may be a plurality of embarkation points. The embarkation points may be arranged such that passengers entering at each embarkation point follow a path that does not cross the path of passengers embarking at a different embarkation point.

The method is preferably applied to the majority of passengers boarding the aircraft and to the majority of the items of luggage to be stored in the lower level. The method may be applied to substantially all of the passengers boarding the aircraft and to substantially all of the items of luggage to be stored in the lower level. It will be appreciated however that there may be reasons why a small minority of the items of luggage to be stored in the aircraft can not be stored by means of a method in accordance with certain embodiments of the invention. For example, it will be understood that passengers who cannot transport their luggage to the aircraft may utilise other means to transport their luggage to the aircraft. Also, certain items of luggage may be handled differently. For example, bulky items of luggage or items that are otherwise difficult to handle may be stored in the aircraft be means of alternative methods. It will also be understood that passengers may in accordance with conventional practice carry hand luggage into the upper level.

An automatic luggage storage system as disclosed in GB Patent Application GB0609891.7 having a filing date of 18 May 2006 Airbus UK Limited ref: XA2219, may be utilised to store, transport and return passengers' luggage. The contents of that application are fully incorporated herein by reference. The aircraft of the present invention may incorporate any of the features disclosed in that UK patent application. In particular, the claims of the present application may be amended to include the features of an aircraft having such a luggage handling system and the features of the luggage handling system.

Certain embodiments of the present invention may be of particular benefit in the form of or in relation to relatively small aircraft, particularly those for short-haul flights.

The aircraft may be of a size equivalent to an aircraft designed to carry no more than 300 passengers, and more preferably no more than 250 passengers, and yet more preferably no more than 220 passengers. The aircraft may be of a size equivalent to an aircraft designed to carry no more than 150 passengers. The aircraft may be of a size equivalent to an aircraft designed to carry more than 10 passengers, and more preferably more than 30 passengers. The aircraft may be lighter than 200 tonnes dry weight, and more preferably lighter than 100 tonnes dry weight. The aircraft may have a fuselage having an external width of less than 6 m, possibly less than 5 m and potentially even as small as less than 4 m. Certain embodiments of the invention concern aircraft of such sizes as allow the provision of an upper and a lower level of heights sufficient for a person to stand, within a fuselage having a width (in view of its length) suitable for accommodating up to 250 passengers (for example, having a width of the order of 4 m or less). Aircraft of such a size and having such a diameter typically have limited room (in height) to provide both an upper and a lower level, in view of the width of the aircraft and the desire to keep the cross-sectional shape of the fuselage either circular or substantially circular. In conventional arrangements, there is typically insufficient room for standing in at least one of the levels of the aircraft. In contrast, embodiments of the present invention allow the provision of upper and lower levels of heights sufficient for a person to stand without needing to increase significantly the circumference of the cross-section of the fuselage from that of a conventional aircraft shape having the same passenger capacity and/or without needing to deviate significantly from a circular cross-section.

Certain embodiments of the invention concern aircraft of the single-aisle type, having a seating layout with a single aisle running along the fuselage of the aircraft separating seats located on either side of the aisle.

It will be appreciated that the various aspects of the invention as described herein are closely related and that therefore features of one aspect of the invention may be incorporated into other aspects of the invention as described herein. Thus, for example, features of the first aspect of the invention may be incorporated into the second and/or third aspects and vice versa. For example, the floor of the upper level of an aircraft according to the second or third may be configured such that the ceiling height in at least part of one or both of the upper and lower levels is sufficient for a person to stand. Also, any aspect of the method of the invention may use, or be performed on, an aircraft according to any other aspect of the invention. Similarly, the aircraft according to any aspect of the invention may be so configured as to be suitable for use in a method according to the fourth aspect of the invention. Features of the apparatus of the invention may be incorporated into the method of the invention and vice versa.

### DESCRIPTION OF THE DRAWINGS

Embodiments of the present invention will now be described by way of example with reference to the accompanying drawings, of which:

FIG. 1 shows a cross-section of an aircraft fuselage of the prior-art;

FIG. 2 shows a cross-section of an aircraft fuselage according to a second embodiment of the invention;

FIG. 3 shows a cross-section of an aircraft fuselage according to a third embodiment of the invention;

FIG. 4 shows a cross-section of an aircraft according to the third embodiment of the invention with an alternative floor structure; and

FIG. 5 shows a plan-view of a seating arrangement for use in an aircraft according to the third embodiment of the invention.

### DETAILED DESCRIPTION

The illustrated embodiments of the invention provide an aircraft having a cargo hold with an increased height to allow access to the cargo hold by passengers and also a method of operating an aircraft having such a cargo hold.

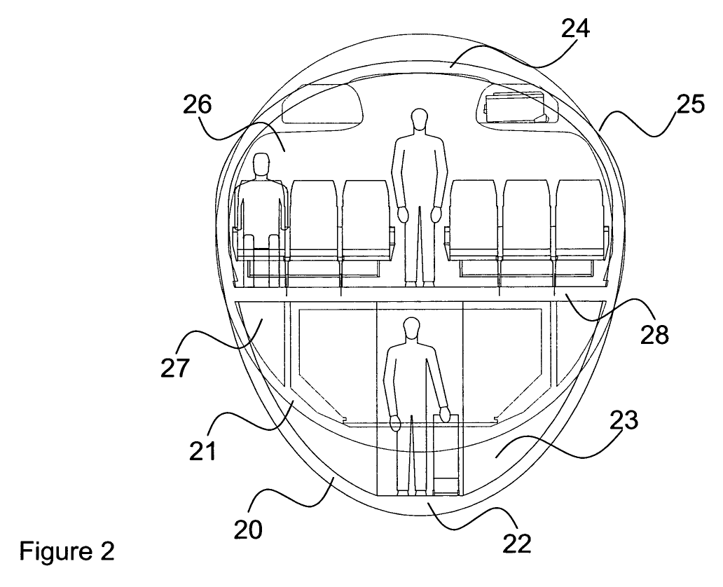

In a method of aircraft operation according to a first embodiment of the invention (not separately illustrated, but achievable by means of using an aircraft in accordance with any of FIGS. 2 to 5, described in further detail below), passengers carry their luggage, to be stored in the cargo hold of the aircraft, to the aircraft rather than checking that luggage in at the airport. Passengers board the aircraft and move to a luggage storage area in the cargo hold of the aircraft, where they deposit their items of luggage. After depositing their luggage, or subsequent to boarding the aircraft if a particular passenger does not have any luggage to store, passengers move to the passenger cabin of the aircraft to take their seats. Passengers with no luggage to store in the cargo hold may either, depending on the layout of the aircraft, pass through the luggage storage area, or may move directly to their seat. Luggage may be stored in a designated area of the cargo hold, or in lockers or other storage arrangements may be provided to allow the safe storage of luggage. Aircraft staff may be available to assist passengers with the storage of luggage. The entrance to the aircraft, luggage storage area of the cargo hold and entrance to the passenger cabin from the cargo hold are located on a path such that passengers embark onto the aircraft and move along the path such that the flow of passengers along the path is substantially entirely one-way. Thus passengers can reach their seats without needing to pass points along the path in more than one direction and/or without needing to reverse their direction along that path. Effectively, a one-way system is formed. Such a layout ensures that passengers flow in a single direction along the path, thereby avoiding queues and collisions as passengers attempt to move past each other. The direction of movement may be implicit in the layout of the aircraft, may be indicated by signs in the aircraft, or aircraft staff may provide instructions and/or directions to passengers. Other methods of ensuring passengers follow the correct path will be apparent to the reader.

When disembarking the aircraft, passengers move to the luggage storage area of the cargo hold to collect their luggage and then leave the aircraft via regular passenger exits. If a passenger does not have luggage to collect, depending on the layout of the aircraft, they may leave the aircraft directly via a regular exit or may pass through the luggage storage area before leaving the aircraft via a regular exit. In the same manner as passengers follow a one-way system when boarding the aircraft, passengers follow a one-way system when leaving.

In order for such a method of loading an aircraft to be practical, passengers must be able to move in the cargo hold in a manner to allow them to conveniently deposit their luggage. However, as has been described above, conventional aircraft have cargo holds with a ceiling height that is not sufficient for a person to stand. FIG. 2 shows a cross-section of the fuselage of an aircraft according to a second embodiment of the present invention, suitable for operation according to the method of the first embodiment of the invention.

The word ‘central’ and its cognate terms are used hereinafter in relation to the fuselage as illustrated in the drawings to refer to the horizontally central region of the cross-section of the fuselage, and not to any other region that could be described as central to a different aspect or dimension of the fuselage.

In FIG. 2 the cross-section of the fuselage is overlaid on a cross-section of a conventional fuselage having a passenger cabin with the same width (and hence capable of housing the same number of seats abreast) to allow comparison therewith.

Fuselage 25 houses an upper level in the form of a passenger cabin 26 and a lower level in the form of a cargo hold 27. The term “cargo hold” is used to distinguish an area of an aircraft used for purposes such as the storage of cargo and luggage, from an area forming a passenger cabin which is primarily for the seating of passengers during a flight. The term “cargo hold” is not intended to suggest that that area is used solely, or even mostly, for the carriage of cargo. Areas described as a “cargo hold” may, as described in detail below, also house facilities for use by passengers on the aircraft. A structure 28 divides the passenger cabin 26 and the cargo hold 27, and so the structure 28 defines both the floor of the passenger cabin 26 and the ceiling of the cargo hold 27. The cross-section of the fuselage of the embodiment is overlaid on the cross-section of the conventional fuselage so that the height of the structure 28 dividing the upper and lower levels is the same in both cross-sections.

The central lower portion 20 (defining the position of the floor of the lower level) of the fuselage extends downwards below the conventional fuselage 21 to increase the height in that area of the lower level to a height sufficient for a person to stand. The centre of the lower level thereby provides an area 22 in which passengers can walk. Luggage storage areas 23 are provided to each side of the walkway, into which luggage can be deposited for storage during the flight. The aircraft is therefore suitable for operation according to the first embodiment of the invention.

The central top section 24 (defining the position of the ceiling of the upper level) of the fuselage according to the second embodiment of the invention is lowered compared to the conventional fuselage, having a comparable width. The height of the upper level is still sufficient however for passengers to stand, and is sufficient for passengers to access all of the seats in the upper-level. The lowering of the central top section of the fuselage reduces the external circumference of the fuselage and thereby reduce aerodynamic drag.

The circumference of the cross-section of the prior art fuselage shown in FIG. 2 is 13.293 m, whereas the cross-section of a fuselage according to the first embodiment of the invention having the same width, has a circumference of 14.493 m, an increase of only 9%. The aerodynamic drag of a fuselage according to this embodiment of the invention is not, therefore, significantly increased.

The cross-sectional shape described with reference to FIG. 2 may be utilised for a substantial part of the length of the passenger cabin (for example substantially the entire length of the cabin).

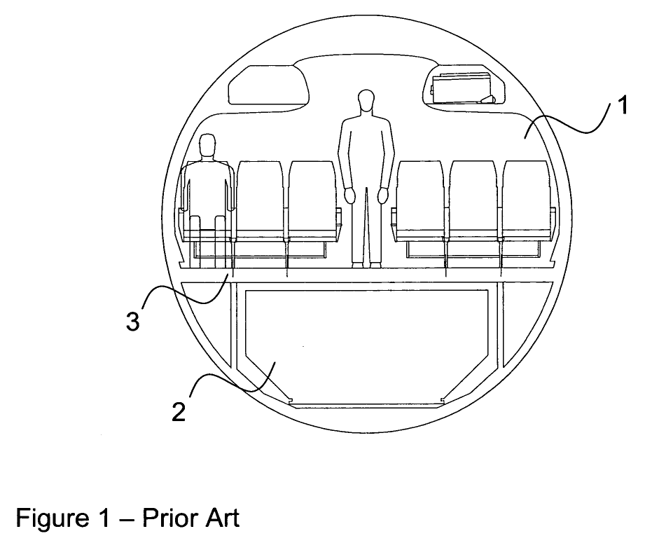

The passenger cabin floor of the prior art fuselage shape shown in FIG. 1 is positioned to provide sufficient headroom to allow access to the outer-most seats in each row. When positioned to provide such access, the height of the cargo hold, below the floor, is not sufficient for a person to stand. However, since the ceiling of the passenger-cabin is curved, the height of the ceiling in the central region of the cross-section is significantly greater than the minimum height needed for passengers to stand in that area.

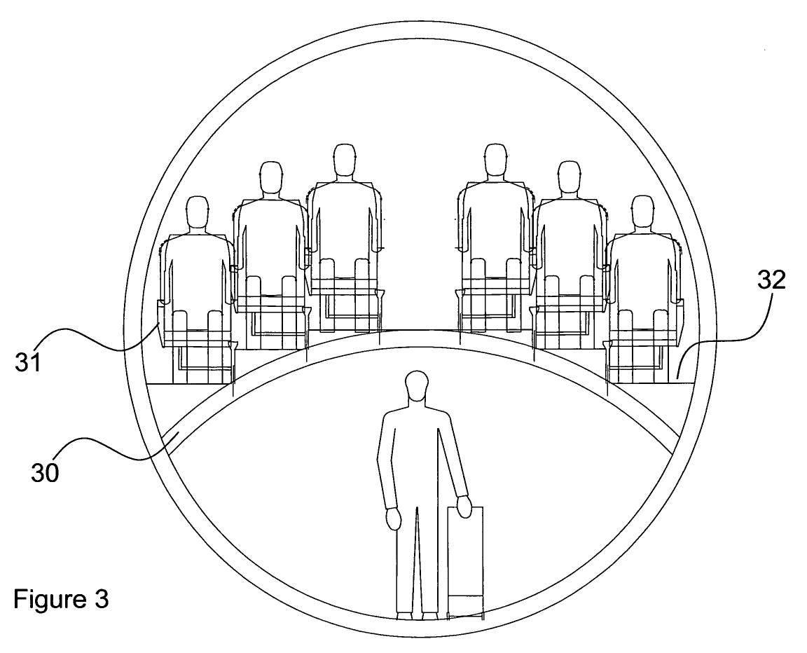

FIG. 3 shows a cross-section of an aircraft fuselage according to a third embodiment of the invention. The floor 30 of the passenger cabin is raised in the centre, compared to the edges. Such a floor shape allows provision of sufficient height in the passenger cabin to stand in the central area and to access all of the seats in each row. Furthermore, the height of the cargo hold, in the centre is sufficient for a person to stand. An aircraft according to the third embodiment of the invention is therefore suitable for use according to the method of the first embodiment of the invention.

Passenger seats 31 are mounted on the floor 30 and stepped level surfaces 32 are provided for passengers' feet, thereby providing comfort for passengers occupying the seats.

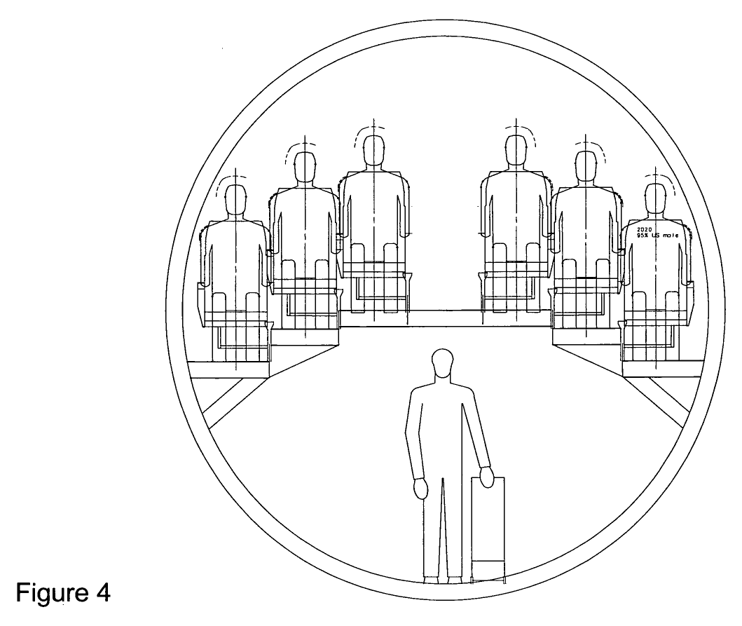

The floor may be formed as an arch, as shown in FIG. 3, and/or may be formed as a series of steps, as shown in FIG. 4. An arched shape has the advantage of being a structurally strong shape. A stepped floor may provide a more convenient construction method and/or more convenient or useable floor space in the passenger cabin. Supports may be utilised between the internal floor and the fuselage to provide additional support to the internal floor.

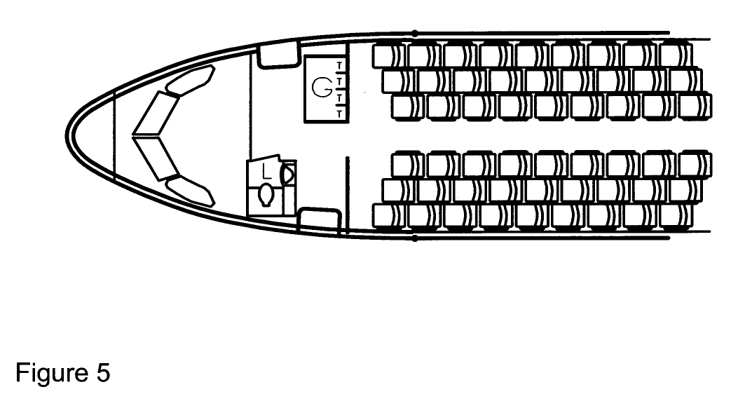

When the non-flat floor of the third embodiment of the invention is utilised, certain seats may overlook other seats, which may not be particularly appealing to passengers. FIG. 5 shows a seating plan for use with the third embodiment of the invention which alleviates the overlook between seats.

The positions of the seats in each row may be staggered, preferably in such a way as to reduce the extent by which a passenger sat in one seat in the row is overlooked by another passenger sat in another seat in the row. For example, seats in each row may be located forwards of the seats located more towards the centre of the fuselage, thereby reducing the overlook of a more outwards seat to a more inwards seats. Seats in each row may alternatively be located rearwards of the seats located more towards the centre of the fuselage, thereby reducing the overlook of a more inwards seat to a more outwards.

Features of the aircraft of the second and third embodiments of the invention may be combined to provide an upper and a lower level having a height sufficient for a person to stand. For example, the non-flat floor and the modified fuselage shape may be provided in combination to further improve the available space in the passenger cabin. Other combinations will be apparent to the reader skilled in the art.

In the second or third embodiments of the invention internal passenger stairs (not shown) may be provided to provide access between the cargo hold of the aircraft and the passenger cabin. The internal stairs may be positioned such that passengers follow a continuous path in a single direction, as described with reference to the method of the first embodiment of the invention. For example, the entrance to the aircraft may be positioned at one end of the fuselage, and the internal stairs at the other end of the fuselage, such that passengers pass along the length of the cargo hold in a single direction as they board the aircraft. Other arrangements of the entrance and stairs are possible as will be clear to the reader.

The passenger-accessible cargo hold may, in addition to or instead of, storing luggage, be utilised to house entertainment facilities for the use by passengers during flight. For example gaming facilities, shops or vending facilities may be provided in the cargo hold. Furthermore, sleeping accommodation may be provided in the cargo hold for use by passengers during flight. The internal stairs described above may be utilised by passengers during flight to access such facilities. The internal stairs may also be utilised by passengers to access luggage during flight, stored in the cargo hold. Two, or more, sets of internal stairs may be provided, thereby allowing a one-way movement system to be implemented to prevent congestion in the relatively small spaces in the cargo hold.

Whilst the present invention has been described and illustrated with reference to particular embodiments, it will be appreciated by those of ordinary skill in the art that the invention lends itself to many different variations not specifically illustrated herein. For that reason, reference should be made to the claims for determining the true scope of the present invention. By way of example, certain variations to the above-described embodiments will now be described.

In an aircraft according to the third embodiment of the invention, the space between the curved floor and the flat floor surface provided for passengers feet may be utilised to house aircraft systems. Furthermore, areas of the cargo hold may also or alternatively be utilised to store aircraft systems.

The aircraft of the second and third embodiments of the invention may also be equipped with regular passenger exits in the passenger cabin to allow operation of the aircraft in a conventional manner. The term “regular exit” means any exit that could be used regularly by passengers to gain access to the aircraft and may cover within its scope an exit that may be used as an emergency exit, but excludes an exit that would only ever be used as an emergency exit. It shall be appreciated that the term ‘exit’ is used herein to refer to an opening through which passengers may embark, as well as disembark, the aircraft. Such an opening will typically be associated with a door. It will be appreciated that in some embodiments additional exits in the form of emergency exits may need to be provided.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An aircraft having a fuselage which houses an upper level and a lower level separated by the floor of the upper level, wherein
the radius of curvature of the uppermost section of the cross-sectional shape of the fuselage is larger than the radius of curvature of the lowermost section of the cross-sectional shape,
the cross-sectional shape of the fuselage is configured such that the ceiling height in at least part of both the upper and lower levels is sufficient for a person to stand, and
one of the upper and lower levels comprises a passenger cabin and the other level comprises a cargo hold.

2. An aircraft according to claim 1, wherein the cross-sectional shape of the fuselage is such that the passenger cabin is wider than the cargo hold.

3. An aircraft according to claim 1, wherein the fuselage is taller than it is wide.

4. An aircraft according to claim 3, wherein the radius of curvature of the lowermost section of the cross-sectional shape of the fuselage is less than the radius of curvature of a circle having a diameter equal to the width of the aircraft fuselage.

5. An aircraft according to claim 1, wherein the radius of curvature of the lowermost section of the cross-sectional shape of the fuselage is less than the radius of curvature of a circle having a diameter equal to the width of the aircraft fuselage.

6. An aircraft according to claim 1, wherein the radius of curvature of the uppermost section of the cross-sectional shape of the fuselage is greater than the radius of curvature of a circle having a diameter equal to the width of the aircraft fuselage.

7. An aircraft according to claim 1, wherein the fuselage has an external width of less than 6 m.

8. An aircraft according to claim 1, wherein the ceiling height of a portion of the upper level at or near the centre of the width of the fuselage is sufficient for a person to stand and the ceiling height of a portion of the lower level at or near the centre of the width of the fuselage is sufficient for a person to stand.

9. An aircraft according to claim 1, wherein both the upper and lower levels are accessible by passengers.

10. An aircraft according to claim 9, further comprising passenger accessible luggage storage compartments in the cargo hold.

11. An aircraft having a fuselage which houses an upper level and a lower level separated by the floor of the upper level, wherein
the floor when viewed in cross-section is raised in the middle.

12. An aircraft according to claim 11, wherein the floor of the upper level is configured such that the ceiling height in at least part of both the upper and lower levels is sufficient for a person to stand.

13. An aircraft according to claim 11, wherein one of the upper and lower levels comprises a passenger cabin and the other level comprises a cargo hold.

14. An aircraft according to claim 13, the passenger cabin comprises seats arranged in rows, each seat being offset in a forwards or backwards direction from a neighbouring seat.

15. An aircraft according to claim 11, wherein the floor comprises a central portion that is higher than a portion of the floor at the edge of the floor.

16. An aircraft according to claim 11, wherein the cross-sectional shape of the floor is a curve, with a peak at the centre of the cross-sectional shape.

17. An aircraft according to claim 11, wherein the cross-sectional shape of the surface of the floor is stepped, rising from the outside edges to the centre.

18. An aircraft according to claim 17, further comprising seats mounted on at least one of the steps.

19. An aircraft according to claim 11, wherein the ceiling height of a portion of the upper level at or near the centre of the width of the fuselage is sufficient for a person to stand and the ceiling height of a portion of the lower level at or near the centre of the width of the fuselage is sufficient for a person to stand.

20. An aircraft according to claim 11, wherein both the upper and lower levels are accessible by passengers.

21. An aircraft according to claim 20, wherein one of the upper and lower levels comprises a passenger cabin and the other level comprises a cargo hold and wherein the aircraft comprises passenger accessible luggage storage compartments in the cargo hold.

22. An aircraft having a fuselage which houses an upper level and a lower level separated by the floor of the upper level, wherein
the floor of the upper level comprises a central portion that is higher than a portion of the floor at the edge of the floor and is so configured such that the ceiling height in at least part of both the upper and lower levels is sufficient for a person to stand, and
one of the upper and lower levels comprises a passenger cabin and the other level comprises a cargo hold.

23. A method of operating an aircraft having a fuselage which houses an upper level and a lower level separated by the floor of the upper level, comprising the steps of:
directing passengers to embark onto the lower level of the aircraft and to deposit their luggage in the lower level, and then
directing passengers to move from the lower level to the upper level, wherein
the passengers are directed to move along a path such that the position of embarking is upstream of the position at which the luggage is deposited which is upstream of the position at which passengers move to the upper level.

24. A method according to claim 23, wherein the method further comprises the step of directing passengers to move between the lower and upper levels via internal passenger stairs.

25. A method according to claim 23, wherein the method includes a step of directing passengers to embark on to the lower level of the aircraft at a different location along the length of the aircraft from the location at which they move to the upper level of the aircraft.

26. A method according to claim 23, wherein the method includes steps of
directing passengers to embark onto the lower level of the aircraft via a plurality of embarkation points, and
directing passengers entering each embarkation point follow a path that does not cross the path of passengers embarking at a different embarkation point.
